(19) United States
(12) Patent Application Publication
(10) Pub. No.: US 2006/0188259 A1
(43) Pub. Date: Aug. 24, 2006

(54) HDSL optical fiber transmission system and method

(76) Inventor: James Furey, Anaheim, CA (US)

Correspondence Address: LAWRENCE S. COHEN, SUITE 1220, 10960 WILSHIRE BLVD, LOS ANGELES, CA, 90024, US

(21) Appl. No.: 11/061,991

(22) Filed: Feb. 19, 2005

(51) Int. Cl. H04J 14/00

(52) U.S. Cl. 398/71; 370/360

(57) ABSTRACT

A method and system for a telecommunications isolator link using optical fibers that will work for whichever of HDSL 1, or 4 or HDSL 2 is being used. A feature of the link is that identical circuits can be used at each end of the link.

### FIELD OF THE INVENTION

The invention relates to transmission of HDSL signals. The invention also relates to processing and transmission of electronic HDSL signals converting the signals to optical signals and then reconverting the signals to electronic signals. The invention also relates to telecommunication isolation links that use optical fibers and transmit HDSL 1, HDSL 2 or HDSL 4 signals.

### BACKGROUND

Isolation links are known for protection from GPR. Such links have a CO circuit at the service provider's side and a SUB circuit at the subscriber's side. These circuits are often referred to as a CO Card and a SUB Card respectively because the circuit is constructed on a printed circuit card. Between the CO Card and the SUB Card optical fibers extend, passing the signals in each direction. The purpose of the optical fiber is to prevent passage of any high voltage that could damage circuitry or related equipment. Each of the CO Card and the SUB Card are also equipped at their entry locations with protection circuitry to prevent any voltage spike from passing into the Card. But, if a large or extended voltage rise occurs that overwhelms the protection elements, it cannot pass through the optical portion of the system. Therefore any damage is prevented or limited. These potentially damaging events are called ground potential rise or GPR. In a typical isolation link installation the SUB Card is installed near to a subscriber or near to a place where a GPR risk is present. The CO Card is installed a sufficient distance away that a GPR event will not affect the CO Card. An isolator link made by RLH Industries of Orange Calif. is one such device; it is specified for use up to twelve miles of single mode optical fiber.

FIG. 1 illustrates a typical installation of a prior art fiber optic link in which the subscriber equipment is near a high voltage transmission line. Other typical installation environments are, power generating plants, power substations, power switchyards, cell site on power towers and co-generation sites. Such an isolation link is made by RLH Industries, Inc. of Orange Calif. designated the RLH Fiber Optic Link.

Fiber optic link systems are compatible with most telecommunication services in common use today. Each fiber optic link card transmits a single copper line over 2-strands of fiber optic cable. The CO side of the link is typically installed outside the high voltage area—typically outside the “300 volt point”. Most CO side cards have the ability to operate from telephone line power (sealing current). From the CO side location a copper derived signal is transmitted over an all-dielectric fiber optic cable (single-mode or multimode). The SUB side of the link is placed at the high voltage site to regenerate the copper signal.

Telecommunications makes use of HDSL signals for rapid high bandwidth transmission of information in digital form. There are several formats for such transmission one of which is HDSL. Typically a system is adapted to transmit one of the three types of HDSL protocols, HDSL 1, HDSL 2 and HDSL 4. The use of each of HDSL1, 2 and 4 is variously adopted by service providers according to their particular needs. HDSL 1 and HDSL 4 use two channels while HDSL 2 uses one channel.

There is presented a need to convert HDSL signals for transmission across optical fiber lines. There is further presented a need for a fiber optic link for HDSL signals and also for a universal link that can be used adaptively for whichever of the HDSL 1,2 or 4 signal protocols is presented.

### SUMMARY OF THE INVENTION

In one aspect the invention is a system and method for transmitting HDSL signals over an optical fiber transmission line by converting the signal from an electrical form to an optical form and then back to electrical form.

In another aspect the invention is an optical isolator link having a CO Card at the service provider's end and a SUB Card at the subscriber's end and optical fiber transmission lines connected between them in which HDSL signals can be converted from electrical to optical form and back to electrical form.

In another aspect the invention is a universal optical isolator link and method that can function with whichever of HDSL1, 2, or 4 signals are to be used.

In another aspect the invention is a universal optical isolator link that converts HDSL1 and 4 and HDSL 2 signal to a 320 MHz signal into an optical transmitter for conversion to an optical signal.

In another aspect the invention is a universal optical isolator link that has identical circuits at each end of optical fiber transmission lines which circuits convert incoming HDSL 1 or 4 or HDSL 2 electrical signals into 320 MHz signals for transmission over an optical transmission line and which also receive optical HDSL 1 or 4 or HDSL 2 320 MHz signals and convert those signals into standard HDSL 1 or 4 or HDSL 2 signals as the case may be.

### BRIEF DESCRIPTION OF DRAWINGS

FIG. 1 is the prior optical fiber isolator link.

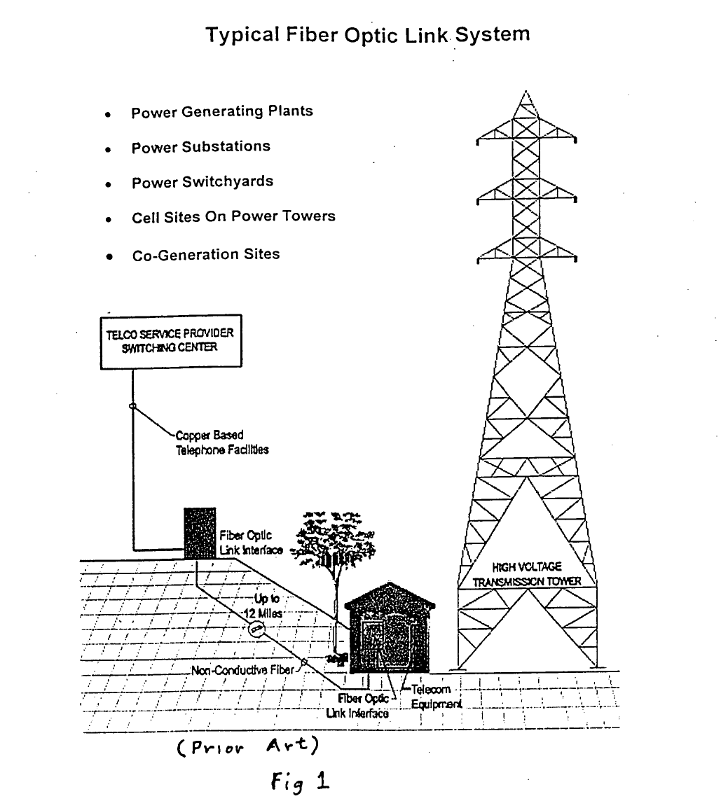

FIG. 2 is a schematic diagram of an optical fiber isolator link that can use the invention.

FIG. 3 is a block diagram of an electronic to optical fiber to electronic communication system for HDSL universal signals that can be used as an isolator link.

FIG. 4 shows the connection scheme for HDSL1, 2 and 4 signals.

FIG. 5 is a schematic diagram of the system of FIG. 1 showing greater detail.

FIG. 6 is a schematic diagram of the system of FIGS. 1 and 2 showing detail of the transhybrid unit.

### DETAILED DESCRIPTION

The invention in one aspect resides in a method and system for bidirectional sending HDSL signals over optical fiber. This method and system requires that the original electric analog HDSL signal be converted to a form and with the same content that can be sent over optical fiber and then at a receiving location be reconverted to the original electrical analog signal.

In another aspect the invention is a method and system for sending HDSL signals through a fiber optic isolator link. In this aspect, an incoming signal from a signal provider through a telecommunications central office is received by the isolator at a Central Office circuit and sent through a transhybrid device that has an analog to digital converter. The digital signal at 32 MHz is then serialized and sped up by a factor of 10 to 320 MHz. That digital signal form is then converted to an optical signal and sent to a subscriber location. At the subscriber location the incoming digital optical signal is converted back to a digital electrical signal, deserialized and demultiplexed and converted back to analog regenerating the original 32 MHz analog electrical signal. Similarly, for a signal sent from a subscriber the same procedure is implemented by the same circuit components as are in the Central Office circuit at the opposite end of the isolator link. Specifically, the signal from the subscriber is received at a Subscriber circuit and sent through a transhybrid device that has an analog to digital converter. The digital signal at 32 MHz is then serialized and sped up to 320 MHz. That digital signal form is then converted to an optical signal and sent to the Central Office circuit. At the central office circuit the digital optical signal is converted back to a digital electrical signal, deserialized and demultiplexed and converted back to an analog signal regenerating the original analog electrical signal that was sent from the subscriber location.

The invention in one aspect resides in such a universal HDSL fiber optic link capable of handling HDSL 1 or 4 or HDSL 2 signals. This aspect is the present preferred embodiment which will be described herein and which description also is sufficient description of each aspect of the invention. In a more particular aspect the universal capability is carried out in circuitry that is the same on both sides of the optical fiber link so that when implemented such as on a circuit card they are interchangeable.

The universal HDSL link that is capable of handling HDSL 1 or 4 or HDSL 2 has two circuits. The first circuit is referred to as the Central Office or CO circuit (also referred to as a CO Card), and the second circuit is referred to as the Subscriber or SUB circuit (also referred to as the SUB Card). “Central Office” is the telephone service provider's equipment office, referred to generally as “Telco”. As will be seen, when the invention is implemented as a bi-directional optical isolator link, the CO circuit and the SUB circuit are identical insofar as processing the HDSL signal. They each can operate universally and bidirectionally with any of HDSL 1 or 4 or HDSL 2.

Insofar as practical herein the signal entering the CO Card from a signal provider will be designated the CO source signal or CO source data stream and the signal entering the SUB Card from its origin (usually the subscriber) will be designated the SUB source signal or SUB source data stream.

In an alternative convention, when the context permits, an HDSL signal received by the respective circuit card from its local HDSL signal source will be referred to as a received signal and an HDSL signal, having been sent by one of the circuit cards over the optical fiber line, that is received and processed by the other card will be referred to as a transmitted signal. Accordingly, it can be appreciated that a received signal at one end of the link is processed by the circuit at that location and is transmitted over the optical fiber as a transmitted signal to the other processing circuit at the other end of the optical fiber link.

It is presumed that those skilled in the art can follow the references in context of describing the flow of signals.

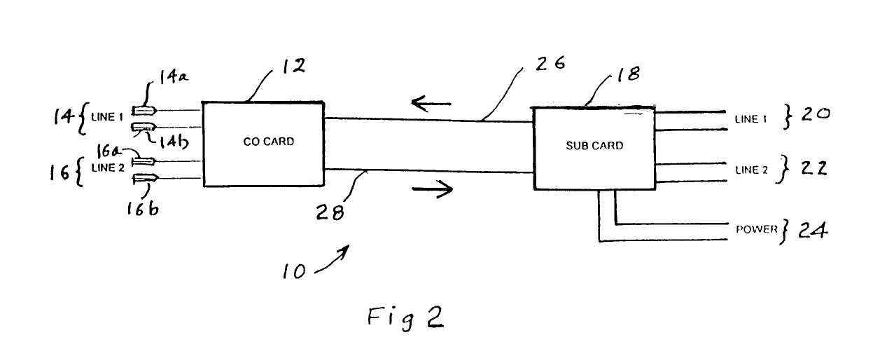

FIG. 2 shows the isolator link system 10 comprising the CO Card 12 with “line 1”, 14, having connectors 14a and 14b and “line 2”,16, having connectors 16a and 16b; and SUB Card 18 with “line 1”, 20, and “line 2”, 22, and power source 24. Between the CO Card 12 and the SUB Card 18 optical fibers extend; the optical fiber 26 carries optical signals (SUB source signals) from the SUB Card 18 to the CO Card 12 and the optical fiber 28 carries CO source signals from the CO Card 12 to the Sub Card 18. The CO card must be connected at the Demark point where the service provider's central office supplies the HDSL line. Typically, this is a location far enough away from the subscriber's (users) location that there is no hazard from the Ground Potential Rise (GPR).

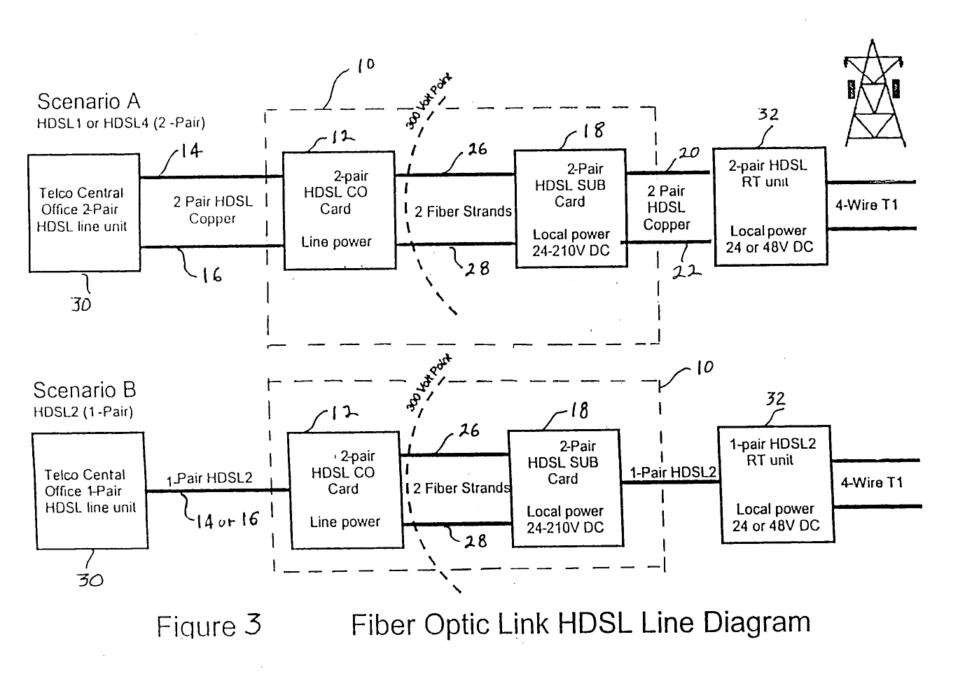

Referring to FIG. 3 the general application of the invention for providing any of HDSL 1 or 4 or HDSL 2 is illustrated by showing it as different scenarios; for HDSL 1 or 4 in Scenario A and for HDSL 2 in Scenario B. As depicted, an HDSL signal comes from the Central Office (CO) 30 as a CO source signal and is delivered to subscriber facility (SUB) 32. Similarly a SUB source signal originated at the SUB 32 and is delivered to the CO 30. As shown in Scenario A, HDSL 1 and 4 operate via 2 pairs of wires 14 and 16 at the CO side and 20 and 22 at the SUB side, each pair defining one of the two lines or channels used by HDSL 1 and HDSL 4. As shown in Scenario B, HDSL 2 operates via a single pair of wires either 14 or 16 at the CO side and either 20 or 22 at the SUB side defining the single line or channel used by HDSL 2. In each case the CO source signal is processed by the system 10, through the CO Card 12, over the optical fiber 28 to the SUB Card 18 and out to the external destination on the SUB side. Similarly the SUB source signal is processed by the system 10, through the SUB Card 18, over the optical fiber 26 to the CO Card 12 and out to the external destination on the CO side.

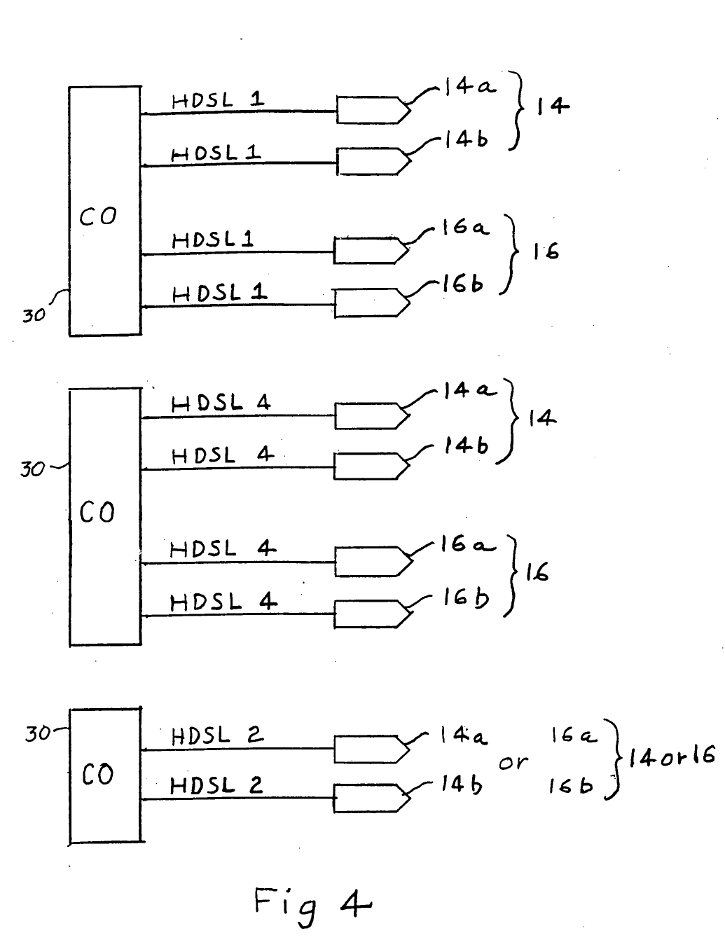

FIGS. 4 shows how the lines from the Central Office 30 are connected to the lines 14 and 16 at the CO Card 12. The HDSL 1 or 4 or HDSL 2 signal is provided by the provider from the CO 30 and is sent to the CO Card 12 by the two lines 14 and 16. In particular, HDSL 1 requires two pair connection and is provided through connections 14a, 14b, 16a and 16b. HDSL 4, which also requires two pair connection, is also connected at connectors 14a, 14b, 16a 15 and 16b. HDSL 2 requires only one pair connection and can be connected through connections 14a and 14b or 16a and 16b. Those skilled in the art will be able to fashion these connections through conventional connectors. At the subscriber side the same connectivity applies where the SUB source signal is transmitted from the subscriber facility which is near a potential GRI source such as a high voltage power line as shown, using lines 20 and 22 for HDSL 1 and 4 or 20 or 22 for HDSL 2.

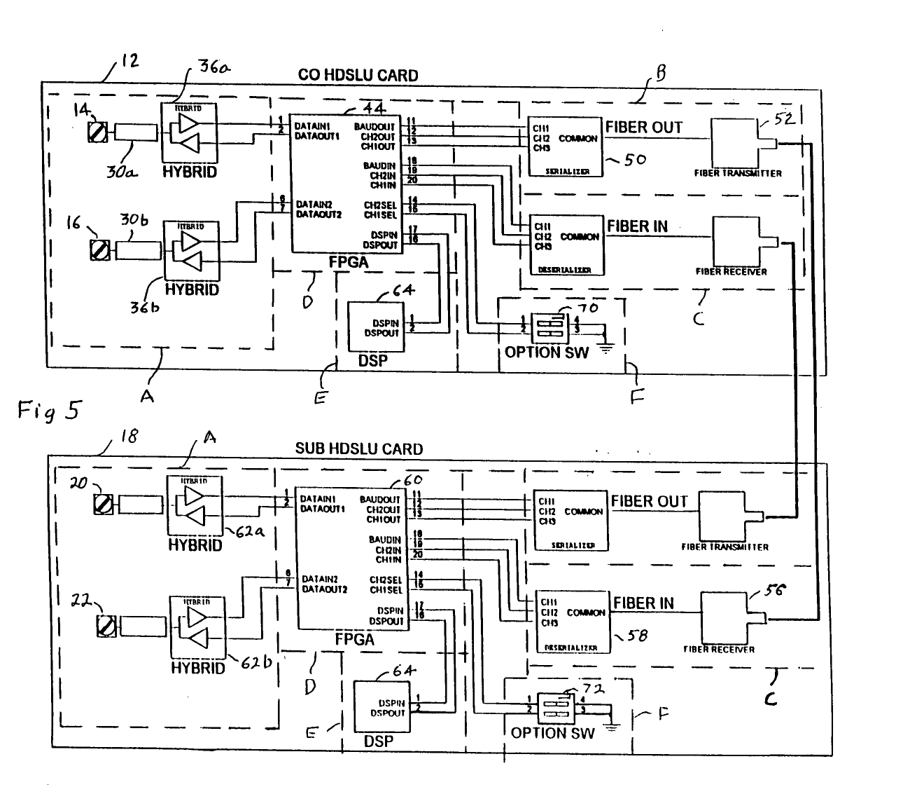

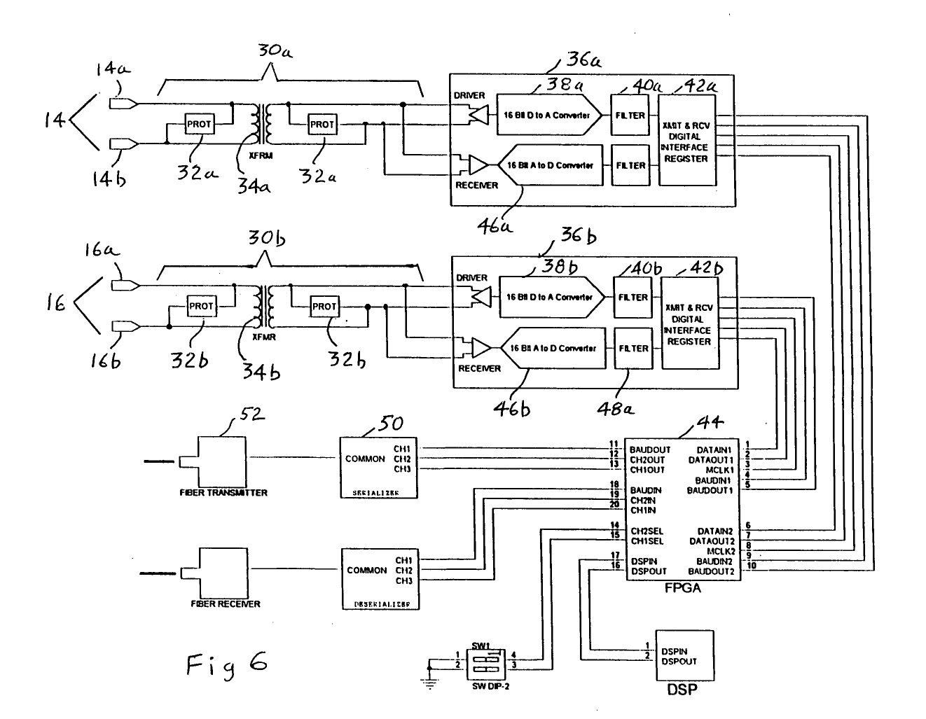

FIG. 5 shows the two identical circuits as circuit boards or cards, CO Card 12 and SUB Card 18, showing the general circuit elements. FIG. 6 shows more detail of the common circuit elements. It will be described in connection with the CO Card 12, but it is appreciated that the description also applies to the SUB Card 18. As will be described below some of the circuit elements are optional and may be used on one but not the other, or omitted on both circuits. As shown in FIG. 5 and 6, a first connector line carrying the CO source single channel HDSL 2 signal or one channel of either HDSL 1 or 4 signals enters the CO Card 12 at input connector line 14 through wires 14a and 14b. A second input connector line is used for the other channel when HDSL 1 or HDSL 4 is used entering the CO Card 12 at connector line 16 through wires 16a and 16b. HDSL 2 has a single channel and only requires 1 or line, while HDSL 1 and 4 each have two channels and require 2 lines.

Similarly an HDSL 2 line carrying the SUB source single channel HDSL 2 signal or one channel of either HDSL 1 or 4 signal enters the SUB card 18 at connection line 20. An additional input connection line 22 is used when HDSL 1 or 4 is used, for the other channel.

Each of the CO Card 12 and the SUB Card 18 can be defined as having a duplex input/output section A, a recieved signal processing section B, a transmitting signal processing section C, and a control logic section D. Also there is an optional DSP section E and an optional switch section F. Other optional circuitry can be associated with the cards, not necessarily the same on each of them. For example, on SUB Card 18, there can be provision for local power that may not be (but could be) used on CO Card 12. However, it is a feature of this invention that the cards are interchangeable, so that for example, provision for local power may be on both even if it is not used on the CO Card when span power is used; and of course, local power may be used on the CO Card in some installations. Alternatively, a SUB Card configured for local power can be used at the CO location when local power instead of span power is to be used there.

The CO Card 12 in section A has various electronic components and devices on it to protect the card itself. These are designated line conditioning circuitry (LCC) 30a and 30b. Two types of protection devices are shown; circuit 32a and 32b protects against spikes and transformer 34a and 34b is an isolation device. These protection devices prevent superfluous voltage spikes and anomalies from damaging the Card. This would include noise and signals exceeding normal operations.

After the LCC 30a, the CO source HDSL 2 signal and one channel of the CO source HDSL 1 or 4 signals goes through an electronic transhybrid 36a. An additional transhybrid 36b is used when HDSL 1 or HDSL 4 is used. The transhybrid circuit 36a and 36b separates the CO source signal (the received signal from the service provider) from the SUB source signal (the transmitted signal from the subscriber). The transhybrid 36a and 36b also specially filter and screen out any signal other than the HDSL signal. Inside the transhybrid 36a and 36b, the CO source signal is transformed from an analog signal into a serial stream of digital data, representing the original received analog signal, through an A to D (analog to digital) converter 38a and 38b and filter 40a and 40b and digital interface register circuit 42a and 42b. This conversion and filtering is controlled by an on-card control logic device 44 (implemented in a FPGA-Field Programmable Gate Array) designated as section D.

Sampled serial digital data of the original received HDSL signal is occurring at 32 MHz (32 Megahertz or 32 million bits of data per second).

Each of the transhybrids 36a and 36b is also configured to operate bidirectionally to also handle the transmitted SUB source signal coming in, so that in the transhybrid 36a and 36b there is a reverse direction D to A converter 46a and 46b and associated filter 48a and 48b.

In the transmitting and signal processing section B there is a serializer 50 and a fiber optic transmitter 46.

Therefore, in the case of HDSL 2, the two 32 MHz data streams and in the case of HDSL 1 or 4, all four 32 MHz data streams (2 for transhybrid 36a and 2 for transhybrid 36b); along with timing and control signals from the control logic circuitry 44 are fed into the serializer 50 on the card. The serializer 50 time multiplexes each 32 MHz channel into a time multiplexed serialized digital data stream of all the 32 MHz channels into one channel. To do so, the serializer increases the speed of the data to ten times the original speed, or 320 MHz (320 million bits of data per second).

The data is then translated from a time multiplexed I serial digita data stream to an optical signal by means of a fiber optic transmitter 52. Data exits the CO Card 12 through this transmitter 52, is transmitted over the optical fiber 54 and is received by the fiber optic receiver 56 on the SUB Card 18. The fiber optic receiver 56 translates the optical signals back into electrical time multiplexed serial digital streamed data at 320 MHz and sends it into the de-serializer 58 on the SUB card 18.

The 320 MHz serialized signal is then separated into its individual 32 MHz channels by the de-serializer 58. The de-serializer 58 and SUB Card control logic device 60 (also an FPGA) control the timing and synchronization of these signals. Each 32 MHz channel is then fed into its corresponding transhybrid by the control logic circuit 60. The control logic circuit 60 also controls the timing of this function.

The transmitted serialized data stream of the original analog signal is then fed into the reverse direction side of the transhybrid 62a if the signal is HDSL 2, and into both transhybrids 62a and 62b if HDSL1 or HDSL4 was used. This (these) transhybrid(s) circuit(s) transform(s) the digital data stream(s) into electrical analog data again by utilizing their internal D to A (Digital to Analog) converters. The details of the transhybrid 56a, 56b are shown in FIG. 6 and have been described above in connection with the CO Card 12 since they are identical to transhybrids 36a and 36b. The transhybrid(s) 62a, 62b then send(s) the analog signal to a final stage amplifier for signal conditioning and then transmits the original received HDSL signal to the output at input/output connection point 20, in the case of HDSL 2 and both input/output connection points 20 and 22 if HDSL 1 or HDSL 4 was used; thus recreating exactly on the other side of the fiber optic link, the same and complete HDSL 1 or 4 or HDSL 2 signal as was provided by the provider.

The two circuits, the CO Card 12 and the SUB Card 18 are duplicates. Therefore, the Sub source signal that is transmitted to and through the SUB Card for transmission over the fiber optic link to the CO Card is processed in the same way as is the CO source signal through the CO Card over the fiber optic link to the SUB Card and the received SUB source signal into the CO Card from the SUB Card is processed in CO Card in the same way as the received COI source signal from the CO Card is processed in the SUB Card. This duplicate circuitry operates in each card in the exact same way utilizing the same control logic and transhybrids, serializer and deserializer, as well as a separate fiber optic transmitter, and fiber optic.

Power for the entire cards' circuit can come from two sources. Circuitry is provided in the CO Card that will take span power from the central office and translate it into three separate supplies for the HDSLU card 12. Span power is voltage provided by the central office to power external cards at the customer's location. These voltages which are created by the on board power circuitry are 3.3 volts, 5 volts and 12 volts. The HDSLU cards 12 and 18 can also be powered by external local power. The external power input can be from 24 to 54 Volts Direct Current (VDC). Currently, circuitry is oriented that span power is generally used on the CO Card 12 and external power is generally used on the SUB Card 18. However sometimes it is desirable or necessary to use local power at the CO location. In such case a SUB Card can be used as a CO Card because the SUB Card is equipped to use local power and is identical in all its operating functions.

A blue Light Emitting Diode (LED) indicator is provided on each card to show that power is active on the card. Another orange LED indicates that the regenerating card is successfully receiving the serial data from the originating card. Two other green LEDs indicate that each HDSL channel on the card is active.

One of the unique features of the circuitry is that normally the transhybrids are used in conjunction with a DSP and software to modify and change or improve the signal received through the hybrid. The present invention uses a hardware only version in which data is not changed, but only passed between the transhybrids on each card, therefore eliminating the need for any software handling. In particular the portion of the signal that contains control bits is deleted by rendering the control bits to a default non-operating condition. However, in some cases, there can be the possibility of certain long distance lines or “noisy lines” that may require more intricate, intelligent and complicated processing of HDSL signals to recreate them from the CO to the SUB card. In such cases an optional DSP capability can be implemented as shown in FIGS. 5 and 6 at 62 for the CO card and at 68 for the SUB card.

As shown in FIGS. 5 and 6 optional switches 70 and 72 numbered as 1-4 may be implemented. These are:

Switch 1 is for turning off and on the HDSLU line 1. If turned on, power is received and HDSLU signal is transmitted and received over line 1. If turned off, power is still received if a line is connected, but no transmission of signal occurs.

Switch 2 is the same as switch 1, for line 2.

Switch 3 is a loop back function. If turned off, normal operation occurs for both lines. If turned on, line 1 and line 2 are connected to each other through all circuitry and fiber optics. Meaning that signals coming in on line 1 go through all normal processes, but if a fiber optic cable is connected between the fiber optic transmitter and fiber optic receiver, then the signal from line 1 will return and be output to line 2. And signal from line 2 will also go to line 1. The purpose of this option is to be able to test an individual card to see if it is functioning without having to connect to its companion card. They help in allowing service personnel to debug a system and tell if only one card has a problem.

Switch 4 currently has no function but may be used for extra gain/volume in the future or it may be used to set which card is the primary and secondary card. In most cases, the CO card is the primary card providing timing to the secondary SUB card for communications. In normal operation, it is set to “CO” for a CO card, and “SUB” for a SUB card. However, it also has a second purpose. CO cards can't be powered from local power. But there can be cases where customers want to use local power on a CO card. A customer can in that case use a SUB card and set switch 2 to “CO” and use local power on it. This SUB card now becomes a primary controlling CO card that already has circuitry to use local power inputs.

The HDSLU card currently doesn't use DSP processing for the control and use of HDSL signals. However, there can be the possibility of certain long distance lines or “noisy” lines that may require more intricate, intelligent and complicated processing of HDSL signals to recreate them from CO to SUB card. Unused connections for a DSP processor and its accompanying circuitry exists on the HDSLU card for this purpose.

When populated, the DSP circuitry can perform complicated mathematical algorithms on the HDSL data from the transhybrids that will screen out and reconstitute an HDSL signal into its most pure form. This reduces interferences such as noise and echoes that can occur on difficult lines.

The data is then sent back to the hybrids for normal operation.

A preferred transhybrid is the AFE1230 made by Burr-Brown, a subsidiary of Texas Instruments.

The following lists the flow of steps for each of the CO Card and the SUB Card:

### Flow Steps

Connection:

1. Connect HDSL lines to inputs of HDSLU CO card.

2. Connect customer HDSL equipment to corresponding outputs of HDSLU SUB card.

3. Apply local power to HDSLU SUB card.

Operation:

1. Received HDSL signal goes into HDSL line 1 and/or 2 input.

2. Corresponding transmitted HDSL signal comes out of same inputs.

3. Received HDSL signal is processed and turned into digital values by A to D hybrid.

4. Digital values from both input 1 and 2 are combined into one stream of data.

5. Digital information is serialized via serializer.

6. Serial data is transmitted via optical transmitter.

7. Received serial data is received by optical receiver.

8. Received data is then deserialized by deserializer.

9. Digital data is sorted into channel 1 or 2 for transmission by receiving card.

10. Digital values are restored to HDSL signal by D to A hybrid.

11. Corresponding HDSL signal is transmitter to corresponding output.

Although particular embodiments of the invention have been described and illustrated herein, it is recognized that modifications and variations may readily occur to those skilled in the art, and consequently it is intended that the claims be interpreted to cover such modifications and equivalents.

What is claimed is:

1. A telecommunications fiber optic isolator link that can universally bidirectionally receive and transmit HDSL 1, 2 and 4 signal comprising;
a first circuit intended to be located at the central office side of the isolator link;
a second circuit intended to be located at the subscriber side of the isolator link;
a first optical fiber connected between the first and second circuits for carrying signals from the first circuit to the second circuit;
a second optical fiber connected between the first and second circuits for carrying signals from the second circuit to the first circuit;
each of said first and second circuits comprising;
a duplex input/output section comprising;
a first signal processing path for bidirectional connection to the single channel of HDSL 2 signals and one of two channels of HDSL 1 and 4 signals;
a second signal processing path for bidirectional connection to the second of the two channels of HDSL 1 and 4 signals;
each of said first and second signal processing paths having an A to D converter for converting received signals from analog form to digital data streams and a D to A converter for converting transmitted signals from serial digital data streams into analog form;
a signal processing and transmitting/receiving section comprising;
a serializer for serializing received digital data streams from the duplex input/output section into a single time multiplexed serial digital data stream at a speed that is a multiple of the original speed of the individual serial digital data streams;
a fiber optic transmitter for converting the received time multiplexed serial digital data stream into an optical signal;
a fiber optic receiver for converting transmitted optical signals into time multiplexed serial digital data streams;
a deserializer for deserializing transmitted time multiplexed serial digital data streams from the fiber optic receiver for transmission to the duplex input/output section as a first signal path of the single channel of HDSL 2 or one of the two channels HDSL 1 or 4;
whereby at each circuit received signals from the single channel as HDSL 2 or from both channels as HDSL 1 or 4 signals are converted into digital data streams and combined in the serializer into a single time multiplexed serial data stream at an increased speed and then converted into an optical signal in the optical transmitter and sent over an optical fiber to the other circuit where it is converted by the optical receiver into a time multiplexed serial data stream and then separated in the deserializer into separate digital data streams into the respective first and second signal paths and then each digital data stream is converted into an analog signal and made available for transmission outside the link such that the single channel of HDSL 2 signals and one of the two channels of HDSL 1 or 4 signals are output at the first signal path and the second channel of HDSL 1 or 4 signals are output at the second signal path.

2. The telecommunications fiber optic isolator link of claim 1 further comprising a control logic section for providing control logic to the duplex input/output section and to the signal processing and transmitting/receiving section.

3. The telecommunications fiber optic isolator link of claim 1 further wherein the first and second signal paths of each of the first and second circuits comprises a line conditioning circuit.

4. The telecommunications fiber optic isolator link of claim 1 wherein each received signal in the serializer is sped up to 320 MHz and in the deserializer is slowed down to 32 MHz.

5. A telecommunications fiber optic isolator link that can universally bidirectionally receive and transmit HDSL 1, 2 and 4 signal comprising;
a first circuit intended to be located at the central office side of the isolator link;
a second circuit intended to be located at the subscriber side of the isolator link;
a first optical fiber connected between the first and second circuits for carrying signals from the first circuit to the second circuit;
a second optical fiber connected between the first and second circuits for carrying signals from the second circuit to the first circuit;
each of said first and second circuits comprising;
a duplex input/output section comprising;
a first signal processing path for bidirectional connection to the single channel of HDSL 2 signals and one of two channels of HDSL 1 and 4 signals;
a second signal processing path for bidirectional connection to the second of the two channels of HDSL 1 and 4 signals;
each of said first and second signal processing paths having a transhybrid for converting received signal into digital form and for converting transmitted signals into analog form
a signal processing and transmitting/receiving section comprising;
a serializer for serializing received digital data streams from the duplex input/output section into a single time multiplexed serial digital data stream at a speed that is a multiple of the original speed of the individual serial digital data streams;
a fiber optic transmitter for converting the received time multiplexed serial digital data stream into an optical signal;
a fiber optic receiver for converting transmitted optical signals into time multiplexed serial digital data streams;
a deserializer for deserializing transmitted time multiplexed serial digital data streams from the fiber optic receiver for transmission to the duplex input/output section as a first signal path of the single channel of HDSL 2 or one of the two channels HDSL 1 or 4; and
a control logic section for providing control logic to the duplex input/output section and to the signal processing and transmitting/receiving section;
whereby at each circuit received signals from the single channel as HDSL 2 or from both channels as HDSL 1 or 4 signals are converted in the transhybrid into digital data streams and combined in the serializer into a single time multiplexed serial data stream at an increased speed and then converted into an optical signal in the optical transmitter and sent over an optical fiber to the other circuit where it is converted by the optical receiver into a time multiplexed serial data stream and then separated in the deserializer into separate digital data streams into the respective first and second signal paths and then each digital data stream is converted by the transhybrids in the into an analog signal and made available for transmission outside the link such that the single channel of HDSL 2 signals and one of the two channels of HDSL 1 or 4 signals are output at the first signal path and the second channel of HDSL 1 or 4 signals are output at the second signal path.

6. The telecommunications fiber optic isolator link of claim 5 further comprising a line conditioning circuit in each of the first and second signal paths

7. The telecommunications fiber optic isolator link of claim 5 wherein the serializer operates to speed up the signal by a factor of ten and the deserializer operates to slow down the signal to a tenth of its speed.

8. The telecommunications fiber optic isolator link of claim 5 wherein said transhybrids comprise an A to D converter for converting received signals to digital form and a D to A converter for converting transmitted signals to analog form and further an element for separating received signals from transmitted signals and a bandpass filter connected to each of the A to D and D to A converters and in each circuit path a digital interface register circuit.

9. The telecommunications fiber optic isolator link of claim 6 further wherein said line conditioning circuit has a surge protection element and a transformer isolation element.

10. A method for selectively transmitting HDSL 2 or HDSL 1 or 4 signals in which HDSL 2 signals are provided in a single channel and HDSL 1 and 4 signals are provided in two channels across optical fiber in which an analog electrical signal of the selected HDSL 1, 2 or 4 protocol is provided comprising;
converting the analog signal into a serial stream of digital data representing the provided analog HDSL signal;
preparing the serial digital data streams for optical transmission through a serializer into a time multiplexed serial digital data stream in a single channel at a higher speed that is a multiple of the original signal speed;
translating the time multiplexed serial digital data stream into a light signal transmittable over an optical fiber transmission line.

11. The method of claim 10 further comprising transmitting the light signal over an optical fiber transmission line.

12. The method of claim 10 further wherein in the serializing step each serial data stream is increased in speed by a factor of ten.

13. The method of claim 10 further comprising;
providing a first signal path to connect to the single HDSL 2 channel and to the first HDSL 1 and HDSL 4 channels;
providing a second signal path to connect to the second HDSL 1 and HDSL 4 channel;
converting incoming electrical analog signal in the first signal path to a serial digital data stream representing an HDSL 2 signal or the first channel of an HDSL 1 or HDSL 4 signal;
converting incoming electrical analog signal in the second signal path to a digital serial digital data stream representing the second channel of an HDSL 1 or HDSL 4 signal and; and
converting the serial digital data streams of the first and second signal paths onto a time multiplexed serial digital data stream at as speed that is a multiple of the original speed of the signals sending the serial data stream or streams to the serializer.

14. The method of claim 11 further comprising;
at the other end of the optical fiber transmission line translating the light signal into an electrical time multiplexed serial digital data stream;
deserializing the time multiplexed serial digital data stream into separate digital data streams representing the single channel of HDSL 2 signals or the HDSL 1 or 4 signals as the case may be; and
converting each serial digital data stream into an analog signal in the selected HDSL form.

15. The method of claim 12 further wherein in the serializing step each time multiplexed serial digital data stream is increased in speed to 320 MHz.

16. The method of claim 14 further wherein in the serializing step each time multiplexed serial digital data stream increased in speed to 320 MHz and in the deserializing step each time multiplexed serial digital data stream is reduced in speed to 32 MHz.

17. A telecommunications fiber optic isolator link that can universally, bidirectionally receive, and transmit data in any of HDSL 1, HDSL 2 and HDSL 4 protocols comprising;
a first circuit designated a CO circuit intended to be located at the central office side of the isolator link; and
a second circuit designated a SUB circuit intended to be located at the subscriber side of the isolator link;
each of the first and second circuits comprising;
a duplex input/output section operative in an input mode to convert the incoming (received) HDSL 2 analog signal or incoming (received) HDSL 1 analog signal or incoming (received) HDSL 4 analog signal, into serial digital data streams, as the case may be, and operative in an output mode to convert transmitted HDSL 2 serial digital data streams or transmitted HDSL 1 serial digital data streams or transmitted HDSL 4 serial digital data streams, as the case may be, into HDSL 2 analog signal or HDSL 1 analog signal or HDSL 4 analog signal, respectively for output;
a control logic section for providing input and output control logic operations for the received and transmitted serial digital data streams;
a transmitting signal processing section operative in an output mode to serialize the received digital serial data streams into a time multiplexed digital serial data stream and to convert that stream into an optical time multiplexed digital serial data stream for transmission into an optical fiber and operative in an output mode to convert transmitted optical time multiplexed digital data stream into an electrical time multiplexed digital serial data stream and to deserialized it into serial digital data streams to the appropriate one of transmitted HDSL 2 serial digital data streams or transmitted HDSL 1 digital data streams or transmitted HDSL 4 serial digital data streams which are then sent to the duplex input/output section for output;
a first optical fiber connected between the transmitting signal processing section of the first circuit and that of the second circuit to carry optical time multiplexed digital serial data from the first circuit to the second circuit; and
a second optical fiber connected between the transmitting signal processing section of the second circuit and that of the first circuit to carry optical time multiplexed digital serial data from the second circuit to the first circuit;
whereby incoming (received) HDSL 2, or, HDSL 1, or HDSL 4 signals are transmitted from each of the first and second circuits to the other.
